(19) United States
(12) Patent Application Publication
(10) Pub. No.: US 2025/0298377 A1
(43) Pub. Date: Sep. 25, 2025

(54) METHOD FOR MANUFACTURING A TIMEPIECE ASSEMBLY, AND TIMEPIECE ASSEMBLY

(71) Applicant: ROLEX SA, Geneva (CH)

(72) Inventors: Carine Bienvenu, Pringy (FR); Laurent Mincone, Jonzier-Epagny (FR); Alain Semoroz, Lausanne (CH)

(73) Assignee: ROLEX SA, Geneva (CH)

(21) Appl. No.: 19/078,693

(22) Filed: Mar. 13, 2025

(30) Foreign Application Priority Data
Mar. 25, 2024 (EP) 24165989.5

(51) Int. Cl. G04B 19/12; G04D 3/00

(52) U.S. Cl. CPC G04B 19/12; G04D 3/0092

(57) ABSTRACT

The method is for producing a timepiece assembly (3) having a first timepiece component (1) with a connecting portion comprising at least one opening (10) and at least one second timepiece component (2) distinct from the first timepiece component (1) having at least one conformation (20), the connecting portion of the first timepiece component (1) and/or the conformation of the second timepiece component (2) forming a part based on a sintered zirconia. The method includes a heat treatment of joining together which is predefined to induce a phase change from the tetragonal phase to the monoclinic phase, or vice versa, of the part based on a sintered zirconia, this phase change inducing a change in the dimensions of at least the part based on a sintered zirconia so as to join together the connecting portion of the first timepiece component (1) and the conformation of the second timepiece component (2).

### CROSS-REFERENCE TO RELATED APPLICATION

This application claims priority of European patent application No. EP24165989.5 filed Mar. 25, 2024, the content of which is hereby incorporated by reference herein in its entirety.

### FIELD OF THE INVENTION

The present invention concerns a timepiece assembly consisting of at least two timepiece components. It also relates to a timepiece movement and to a timepiece comprising at least one such timepiece assembly. It also relates to a method of producing such a timepiece assembly.

### BACKGROUND ART

Ceramics are increasingly used in timepieces, for example to form timepiece arbors, because its intrinsic mechanical properties, notably of hardness, and its insensitivity to magnetic fields are very advantageous for numerous timepiece components. It is also known to use a ceramic for timepiece exterior components.

Traditional solutions for assembling timepiece components are delicate if at least one of the components involved is made of ceramic. Some solutions take advantage of the properties of a second component of the assembly when the latter is not made of ceramic. These solutions therefore impose constraints on the fabrication of the second component of the assembly. Furthermore, these solutions are not always suitable when it is a question for example of assembling two timepiece components both made of ceramic. In such a case it is known to use gluing, which has a first disadvantage of requiring complete control of the amount of glue and aligning and keeping the components aligned while the glue sets and dries, and a second disadvantage of depending on possible deterioration of the glue over time. Alternatively, fastening the two ceramic timepiece components together by driving could be attempted, which is complicated because the driving force risks breaking one of the components. Driving is moreover not suitable when a ceramic component has a shape rendering it particularly fragile.

### SUMMARY OF THE INVENTION

Thus the present invention has for object improving the production of a timepiece assembly and notably defining a timepiece assembly solution that is particularly suitable for the use of a ceramic and particularly suitable for a timepiece assembly involving assembling two ceramic components.

To be more precise, the invention has for object defining a timepiece assembly solution that is reliable, durable and easy to employ.

To this end, the invention is based on a method of producing a timepiece assembly comprising a first timepiece component comprising a connecting portion comprising at least one opening and at least one second timepiece component distinct from the first timepiece component comprising at least one conformation, said connecting portion of the first timepiece component and/or the conformation of the second timepiece component forming a part based on a sintered zirconia, which method comprises a step of joining together by heat treatment, said heat treatment being predefined to induce a phase change from the tetragonal phase to the monoclinic phase, or vice versa, of said part based on a sintered zirconia, this phase change inducing a change of the dimensions of at least said part based on a sintered zirconia so as to join together the connecting portion of the first timepiece component and the conformation of the second timepiece component.

The invention also relates to a timepiece assembly comprising a first timepiece component comprising a connecting portion based on a tetragonal phase zirconia comprising at least one opening and at least one distinct second timepiece component comprising at least one conformation or comprising a first timepiece component comprising a connecting portion comprising at least one opening and at least one distinct second timepiece component comprising at least one conformation based on a monoclinic phase zirconia, the first timepiece component and the second timepiece component being clamped together without deformation of the opening in the first timepiece component on the at least one conformation of the second timepiece component.

The invention is more particularly defined by the claims.

### BRIEF DESCRIPTION OF THE DRAWINGS

The objects, features and advantages of the present invention are described in detail in the following non-limiting description of particular embodiments with reference to the appended figures, in which:

FIG. 1 represents a view from above of a watch case comprising a ceramic applique assembled to a ceramic bezel disc according to a first embodiment of the invention.

FIG. 2 represents a partial side view in section of the bezel disc at the level of the timepiece assembly according to the first embodiment of the invention.

FIG. 3 represents a partial view from above of the bezel disc at the level of the timepiece assembly according to the first embodiment of the invention.

FIG. 4 represents a view from above of a bezel disc comprising an assembled ceramic applique a second embodiment of the invention.

FIG. 5 represents a partial side view in section of the bezel disc at the level of the timepiece assembly according to the second embodiment of the invention.

FIG. 6 represents a partial view from above of the bezel disc at the level of the timepiece assembly according to the second embodiment of the invention.

FIG. 7 represents a view from above of assembled appliques on a dial to form a timepiece assembly according to a third embodiment of the invention.

FIG. 8 represents a partial side view in section of the dial at the level of the timepiece assembly according to the third embodiment of the invention.

FIG. 9 represents a view from above of a bezel disc comprising an assembled ceramic applique according to a fourth embodiment of the invention.

FIG. 10 represents a view from above of an assembly of a bezel ring and a bezel disc according to a fifth embodiment of the invention.

FIG. 11 represents a partial side view in section of the timepiece assembly according to the fifth embodiment of the invention.

FIG. 12 represents a partial side view in section of a timepiece assembly according to a variant of the fifth embodiment of the invention.

FIG. 13 represents a perspective view of a timepiece assembly comprising a pinion assembled to an arbor according to a sixth embodiment of the invention.

FIG. 14 represents a side view in section of the timepiece assembly according to the sixth embodiment of the invention.

FIG. 15 represents a view from above of the timepiece assembly according to the sixth embodiment of the invention.

FIG. 16 represents a side view in section of a timepiece assembly comprising a pinion assembled to an arbor according to a seventh embodiment of the invention.

FIG. 17 represents a side view in section of a timepiece assembly according to an eighth embodiment of the invention.

FIG. 18 represents the evolution of the relative deformation of a sample of a black zirconia as a function of temperature T during the preliminary heat treatment and the heat treatment of joining together in one embodiment of the invention.

FIG. 19 represents the evolution of the temperature of the sample of a black zirconia as a function of time during measurements of the FIG. 18.

### DETAILED DESCRIPTION OF PARTICULAR EMBODIMENTS

To simplify the description, we will by convention call the vertical direction the direction perpendicular to the plane of a timepiece (to the plane of the dial for example), that is to say the direction in which a user looks at the timepiece to read the time. The adjective “above” will be used for the position relative to the timepiece enabling reading of the time in the vertical direction, as opposed to the adjective “below”. By extension, these definitions will be used for a timepiece assembly forming a sub-assembly of a timepiece, even without regard to their position in a timepiece, referring to the intended position of that timepiece assembly in a timepiece.

The adjective “transverse” will be used to designate a direction perpendicular to the vertical direction. A side view is a view in the transverse direction.

The invention advantageously relates to a method of producing a timepiece assembly. Such a method has for objective assembling at least two distinct timepiece components in a manner of joining together, whether fixed or mobile relative to one another, to form a joint together unitary assembly that we will call a timepiece assembly.

In accordance with the concept of the invention, at least one of the timepiece components of the timepiece assembly consists mostly of a sintered zirconia, that is to say consists in whole or in part of a sintered zirconia, and/or advantageously comprises at least 50% by weight of a sintered zirconia. We will use the expression referring to a timepiece component “based on” a sintered zirconia to designate the fact of comprising at least 50% by weight of a sintered zirconia. The sintered zirconia can therefore be associated with another material so as to form a composite material. The timepiece component will moreover advantageously be based entirely on a sintered zirconia, or made entirely of a sintered zirconia, that is to say that its material will be identical throughout its volume. We will use hereinafter the simplified expression “sintered zirconia timepiece component” or “sintered zirconia timepiece component portion” to designate all the configurations mentioned hereinabove.

The sintered zirconia used is notably present at the level of a connecting portion of a timepiece component, that is to say a portion that comprises a connecting surface of said timepiece component consisting mostly of a sintered zirconia.

Additionally, in accordance with the concept of the invention, the sintered zirconia has a stabilized tetragonal phase structure so as to enable a phase change from the tetragonal phase to the monoclinic phase by heat treatment at ambient pressure and at a relatively low temperature, notably between 100° C. and 400° C. A number of factors intervene in achieving this particular property of the aforementioned aptitude for a phase change, and an example will be described hereinafter of zirconias that have this property, which is far from being the case for all tetragonal phase zirconias. Hereinafter we will use the simplified expression “particular tetragonal phase” to designate a zirconia tetragonal phase having this particular property, as explained hereinabove.

Note that it is possible to observe a zirconia and to identify the tetragonal, monoclinic, or even cubic phase of its structure. To this end, X-ray diffraction measurement enables for example direct characterization of the structure, even making it possible to obtain with precision the concentrations of each tetragonal, monoclinic and cubic phase in the case of a multiphase structure.

Note further that, in the case of a tetragonal phase that is transformed into the monoclinic phase, the dimensions of the zirconia change by increasing its volume.

This phenomenon, which is exploited by the invention, as will be described below, enables indirect observation of the phase of the zirconia by dilatometry. This observation of the change of the dimensions of a zirconia over time and/or as a function of temperature makes it possible to determine the occurrence of a phase change from tetragonal to monoclinic and vice versa, and even to determine the kinetics of such a phase change. Thus, when the initial phase and the initial dimensions of a sample are known, dilatometry enables precise indirect determination of the phase on the basis of the change of dimension.

In a further variant, the person skilled in the art could determine the phase of the zirconia by any other known means. This possibility of determining the phase of the zirconia, as well as its phase change, enables the person skilled in the art to analyze a certain zirconia easily and empirically and to determine for example, using the method that will be described hereinafter, if it can be used to form a connecting portion of a timepiece component or not.

Finally, in all the embodiments envisaged it is advantageous to use a technical zirconia and therefore a sintered technical zirconia. The adjective “technical” refers to the high performance properties of the chosen zirconias. Indeed, technical zirconias can have very high mechanical, thermal, and even electrical and/or biochemical properties, as well as chemical inertness and amagnetism, which render them suitable for forming a timepiece component. The technical zirconias used here are characterized by their stable crystalline phase, for example with the dominating tetragonal phase, and their chemical composition that renders them stable relative to a phase change from tetragonal to monoclinic. The powders used to manufacture technical zirconias are obtained from purified synthetic powders and not from natural mineral powders.

A method of producing a timepiece assembly will now be described.

A preliminary step of the method in accordance with this embodiment consists in providing at least two distinct timepiece components that are intended to be assembled to form a joint together assembly.

A first timepiece component comprises at least one first connecting portion made of a sintered zirconia or based on a sintered zirconia, in the particular tetragonal phase, as defined above. This first connecting portion forms a female type connection intended to receive the connection with a second timepiece component that will be described hereinafter. This first connecting portion therefore has the overall shape of an opening, or more generally comprises at least one opening, the term “opening” designating a multitude of shapes, precise examples of which will be mentioned hereinafter.

A second timepiece component has a shape matching that of the first timepiece component, and notably a second connecting portion forming a male type connection intended to cooperate with the first connecting portion of the first timepiece component, that is to say said opening in the first timepiece component. We will use the generic term “conformation” to designate the shape of this second connecting portion intended to cooperate with the opening in the first timepiece component. This conformation can have a multitude of shapes provided that it is able to cooperate with the opening in the first timepiece component to enable the connection between the two timepiece components.

The production method includes a first step consisting in subjecting the first timepiece component to a preliminary heat treatment so as to induce a first phase change of the sintered zirconia, at least at the level of the first connecting portion, which goes from its tetragonal phase to a monoclinic phase. This first phase change induces enlargement of the opening in the first timepiece component. This modification of the dimensions of the first timepiece component arises intrinsically from the phase change. The phase change can be partial but will be chosen so as to achieve the required enlargement.

The tetragonal phase of the sintered zirconia of the first timepiece component is advantageously a particular phase chosen for its propensity to change phase to the monoclinic phase relatively easily, that is to say by means of a relatively low temperature, preferably between 100° C. and 400° C., at ambient pressure. Executing an operation at ambient pressure, or even at a relatively low pressure, below 2 atm, and without stress makes it possible to avoid subjecting the timepiece component to too high a stress and to simplify the method, using ovens of simple construction without complications because of the high pressure. This is advantageous since a timepiece component is generally characterized by a very small dimension and/or by very small portions of particularly fragile shape. Thus if a timepiece component were to be stressed, there would exist a risk of breaking the timepiece component and/or compromising its geometric integrity. Furthermore, it appears that such heat treatment makes it possible to achieve a sufficient result in a relatively short time, for example one hour or even a few hours. More generally, the duration of the heat treatment can be between 30 minutes and 10 hours. In all cases, the heat treatment advantageously takes less than 10 hours or even less than 5 hours or even less than 3 hours. It is also possible to carry out such heat treatment in a neutral atmosphere or in air and in all cases without necessitating an additional external input, for example without adding water. Given the conditions mentioned hereinabove, the heat treatment has the advantage of enabling the use of a simple oven to implement it. Alternatively, addition of water may be used.

The production method then includes a second step consisting, notably and advantageously at ambient temperature, in assembling into an intermediate configuration said two timepiece components, so that the conformation of the second timepiece component is positioned at least partially through the opening in the first timepiece component. In this intermediate configuration of the assembly of the two timepiece components the two timepiece components are in their final position relative to one another but are not yet joint together. Thus the respective dimensions of the opening, enlarged by the preliminary heat treatment, and of the conformation are such that the conformation is positioned in the opening and separated from the surfaces of the opening by a small distance, which represents a clearance between the two timepiece components. At this stage, the two timepiece components therefore do not enter into any or much contact with one another in the intermediate configuration.

A means is advantageously used to hold this intermediate configuration in a stable manner. For example, one or both timepiece components can be held by a support or have complementary shapes enabling their relative retention. Alternatively, this means can take the form of an intermediate binder that will disappear during the heat treatment of joining together.

The production method includes a third step consisting in subjecting said timepiece assembly in its intermediate configuration to a heat treatment of joining together so as to induce a second phase change of the sintered zirconia of the first timepiece component, which returns partially or totally from the monoclinic phase to the tetragonal phase, which induces shrinkage of the opening in the first timepiece component so as to join the first and the second timepiece component of the timepiece assembly in a final configuration. In this step the sintered zirconia of the first component substantially returns to its initial phase and its initial dimensions as they were before the preliminary heat treatment was carried out.

This heat treatment of joining together is advantageously likewise carried out at ambient pressure, or even at a relatively low pressure, below 2 atm. Furthermore, in one embodiment it is carried out at a temperature between 1100° C. and 1300° C. Likewise, its duration may be between 1 hour and a few hours, more generally between 30 minutes and 10 hours. This heat treatment of joining together advantageously has a duration less than 10 hours or even less than 5 hours or even less than 3 hours.

This connection between the two timepiece components can consist in joining together the two timepiece components as a result of clamping the connecting surface delimiting the opening in the first timepiece component onto the conformation of the second timepiece component during the second modification of the dimensions of the first timepiece component. Alternatively, this connection may entail retention of the second timepiece component in a housing formed by the opening in the first timepiece component, the two timepiece components being connected in a timepiece assembly in which the second timepiece component is still mobile relative to the first timepiece component, in particular in translation and/or in rotation.

Note that this production method is compatible with the use of a second component that can comprise a multitude of different materials, notably at the level of its second connecting portion, which comprises the conformation. Notably, at least the conformation of the second timepiece component can also be made of a ceramic.

Note that the material of the second timepiece component is chosen so that its possible deformation by thermal expansion during the heat treatment of joining together does not limit the aforementioned deformation of the first timepiece component so as not to oppose the connection, and therefore the assembly, effected by the phase change of the zirconia of the first timepiece component. Notably, to prevent it from breaking, the possible change of dimensions by thermal expansion of the conformation of the second timepiece component in the assembly does not stress the first timepiece component outside its elastic limit.

The concept of the invention has the advantage of being usable with a multitude of timepiece components that may include a multitude of materials and/or have a multitude of shapes.

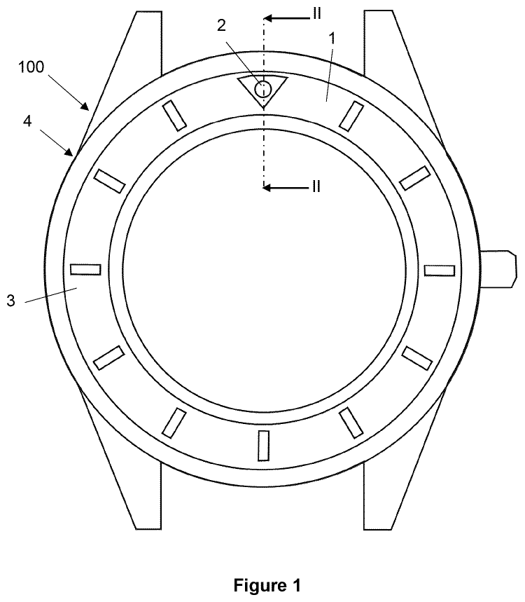

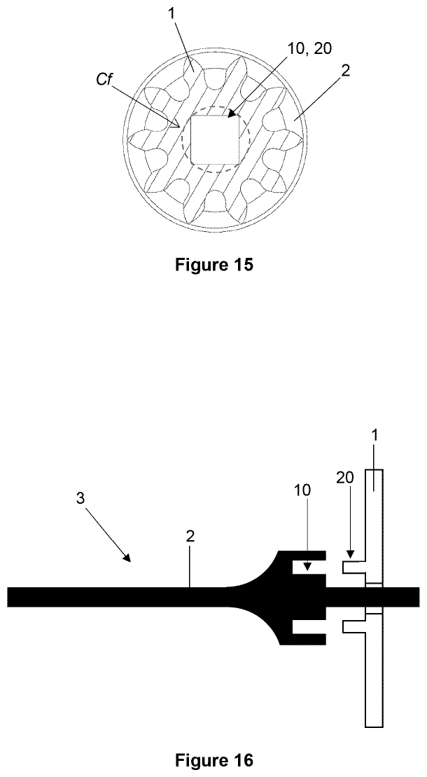

Thus FIGS. 1 to 17 represent by way of example timepiece assemblies obtained by application of the production method as described above.

For simplicity, in these figures the same reference numbers are used to designate the first timepiece component and the second timepiece component and their corresponding connecting portions, even if those timepiece components and their shapes differ.

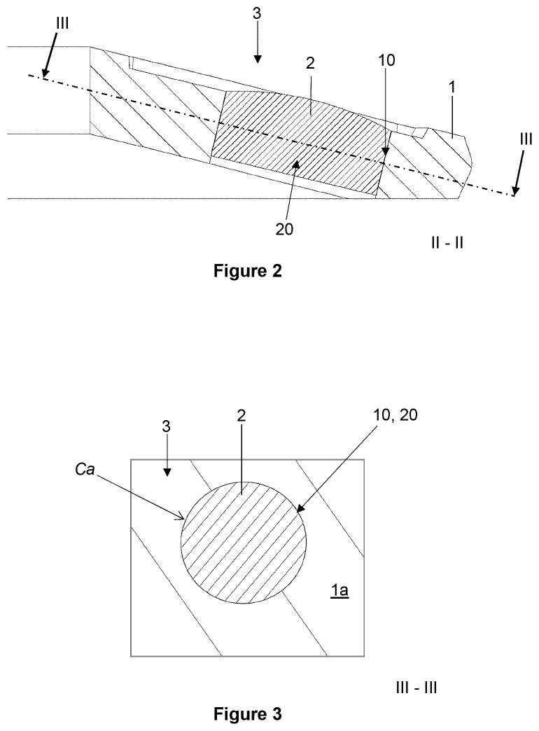

Thus FIG. 1 represents a first embodiment in which a watch case 100 provided with a bezel 4, itself comprising an assembled bezel disc comprising a bezel disc onto which a cylindrical applique is fixed by means of the method described hereinabove. In this first embodiment the timepiece assembly 3 is therefore an assembled bezel disc, the first timepiece component 1 is a bezel disc comprising a cylindrical opening 10 formed in the bezel disc and the second timepiece component 2 is a cylindrical applique, the conformation 20 of which is a cylindrical portion of the applique, specially made more visible in FIGS. 2 and 3. In this embodiment the opening 10 and the conformation 20 have a diameter of the order of 2.2 mm. Alternatively, the opening 10 and the conformation 20 could be some other shape and more generally be inscribed inside a circle Ca having a diameter of 2.2 mm once the applique has been fixed to the bezel disc.

In this embodiment the first timepiece component 1, that is to say the bezel disc, is made of a black zirconia or is based on or consists mostly of a black zirconia. In the method described this sintered zirconia is more particularly adapted to change phase. The second timepiece component 2, that is to say the applique, is made of a blue zirconia or is even based on or consists mostly of a blue zirconia. Here, this blue zirconia remains insensitive to the heat treatment of joining together of the third step.

A black zirconia is a tetragonal phase zirconia stable at ambient temperature thanks to the addition of metal oxides, for example cerium and/or calcium and/or magnesium and/or yttrium oxide. The black color is obtained by adding 1.5-5% by weight of spinels of the type (CoZn)(FeAl)₂O₄ to the base composition comprising 1.8 to 5% mol of metal oxides, for example Y₂O₃, the balance being ZrO₂, as described for example in the document EP1857428. This black zirconia is adapted to go partially or totally from the tetragonal phase to the monoclinic phase because of the effect of a high temperature. The duration of this phase change can be of the order of one hour or even several hours depending on the temperature parameters. The phenomenon can moreover be accelerated in humid air.

Blue zirconia is a tetragonal phase zirconia stable at ambient temperature thanks to the addition of metal oxides, typically cerium and/or calcium and/or magnesium and/or yttrium oxide. The blue color is obtained by adding particles of spinel CoAl₂O₄ at 2 to 4% by weight to the base composition consisting of 3 to 5% mol of metal oxides, for example Y₂O₃, the balance being ZrO₂.

The characteristics of the powders for preparing the zirconias of these timepiece components are set out in Table 1 below and the characteristics of the steps of producing these timepiece components are detailed in Table 2.

TABLE 1
Types of zirconia used in the embodiment

| Color | Pigment | Concentration |
|---|---|---|
| Black | (CoZn)(FeAl)₂O₄ * | 3-5 wt % |
| Blue | CoAl₂O₄ ** | 2-4 wt % |

* According to the document EP1857428
** Known by a person skilled in the art as “cobalt blue”, widely used incoloring ceramics.

TABLE 2
Method of producing bezel discs and appliques in the embodiment

| Step | Conditions |
|---|---|
| Powder | Powders defined in Table 1 |
| Green body shaping | Uni-axial pressing/injection |
| Machining | |
| Debinding | Oven, 450° C. |
| Pre-sintering | Oven, 750° C. |
| Sintering | Oven, 1450° C. |

The heat treatments were carried out in ambient air in a non-hermetically sealed electrically heated oven of standard construction for technical ceramics and capable reaching temperatures of the order of 1400° C. to 1700° C.

Assembled bezel discs were produced in the context of trials. Notably, black zirconia bezel discs each including an opening of 2.186 mm diameter designed to receive a blue zirconia applique were heated to 250° C. for 2 hours in ambient air and then cooled to ambient temperature. The preliminary heat treatment of this first step causes a 0.01 mm enlargement of the diameter of the opening.

A blue applique is placed in each of the openings in the disc after which these timepiece assemblies in the intermediate configuration are heated to 1150° C. for 1.5 h. The black zirconia discs revert to their initial dimensions, which makes it possible to clamp the appliques.

Table 3 below summarizes the details of these various steps for one embodiment:

TABLE 3
Steps of preparing two black zirconia bezel discs with dimension
measurements in the embodiment

| Preliminary heat treatment-expansion by the phase change | |
|---|---|
| from tetragonal to monoclinic | |
| Heating from 40° C. to 250° C. at the rate of 300° C/h | |
| Maintaining at 250° C. for 2 h | |
| Cooling from 250° C. to 40° C. at the rate of 200° C./h | |
| Measurements | |
| Before treatment | After treatment |
| Bezel disc no. 1 | |
| Insider diameter | Inside diameter |
| Ø31.57 mm | Ø31.73 mm |
| Opening #1 Ø2.186 mm | Opening #1 Ø2.196 mm |
| Bezel disc no. 2 | |
| Insider diameter | Inside diameter |
| Ø31.57 mm | Ø31.77 mm |
| Opening #2 Ø2.186 mm | Opening #1 Ø2.196 mm |

Placing the conformation

Diameter of the conformation
2.191-2.194

Heat treatment of joining together-phase change from
monoclinic to tetragonal
Heating from 40° C. to 1150° C. at the rate of 200° C/h
Maintaining at 1150° C. for 1.5 h
Cooling from 1150° C. to 40° C. at the rate of 200° C./h

According to Table 3 above, the mean linear deformation of the black zirconia discs caused by the phase change can be estimated at 0.57% based on the inside diameter measurements.

To depict clearly the change of dimension exploited by the invention, a dilatometer is used to observe the behavior of control samples in the form of rectangular parallelepipeds with a square base with a side length of 4.5 mm and a height of 13 mm. The main result obtained with the aid of the dilatometer is the measurement of a relative linear deformation of a sample as a function of time and temperature.

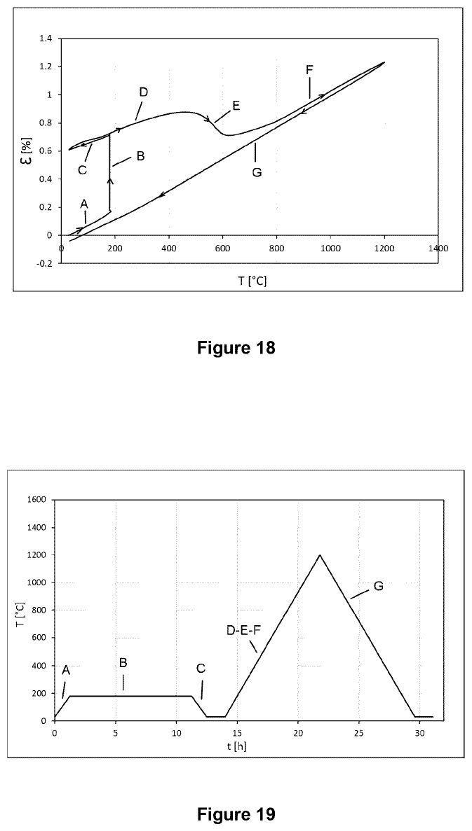

FIG. 18 depicts the evolution of relative deformation & of a black zirconia sample as a function of temperature T, as measured by means of a dilatometer. In the context of the invention this evolution represents expansion during the preliminary heat treatment and the heat treatment of joining together. The arrows on the expansion curve indicate the evolution over time. FIG. 19 represents the evolution of the temperature of the black zirconia sample during the expansion measurements shown in FIG. 18. In FIG. 18, the parts A, B and C represent the preliminary heat treatment. The part A represents the linear rise in temperature of the sample to 180° C. accompanied by the linear expansion of the sample with no phase change. Part B represents the approximately 0.5% deformation during the period of 10 h at the constant temperature of 180° C. This reflects expansion caused by the phase transition from tetragonal to monoclinic. Part C represents the cooling to ambient temperature. The rest of the curve, marked D, E and F, represents the heat treatment of joining together that restores the initial dimensions because of the phase transformation from monoclinic to tetragonal during heating at 1200° C. In part D the expansion of the sample follows the rise in temperature in a linear manner. Thereafter, in part E, the expansion decreases in a non-linear manner because of the phase transformation and resumes linear growth in part F. Part G shows the linear shrinkage during the fall in temperature. Note that outside the non-linear changes of deformation because of the phase transformations the deformation relative to temperature remains linear with a normal coefficient of thermal expansion of zirconia.

The phase change during the heat treatment occurs in a relatively wide range of temperature for the zirconia studied, between 100° C. and approximately 400° C., with a maximum change rate at around 180° C. The phase change from monoclinic to tetragonal during the heat treatment of joining together can already be observed as a reduction of the expansion (part E) toward 600° C., but it becomes permanent after cooling only well above 800° C., typically around 1200° C. Consequently, if the heat treatment of joining together is stopped before reaching 800° C. the restoration due to the phase transformation is incomplete and the sample will remain significantly expanded after cooling to ambient temperature.

Table 4 below presents the proportion of the monoclinic phase in black and blue zirconia before and after heat treatment for 10 h at 180° C. in ambient air, evaluated by two different methods. It is apparent that there exists a small difference between the proportion of the monoclinic phase measured by dilatometry and that obtained from an X-ray diffraction measurement. The lower value of the latter method could be attributed to the low penetration of the X-rays into the measured sample, of the order of a few micrometers.

TABLE 4

| | | X-ray |
|---|---|---|
| | Dilatometry | diffraction |
| Before the preliminary | | |
| heat treatment | | |
| Black zirconia | 0* | 5%-6% |
| Blue zirconia | 0* | <1% |
| After the preliminary | | |
| heat treatment | | |
| Black zirconia | 35%-45% | 35%-40% |
| Blue zirconia | <1% | <1% |

*In the case of measurement using the dilatometer, which measures a variation of phase and not an absolute phase concentration, it is assumed that the initial proportion of monoclinic phase before the heat treatments is zero.

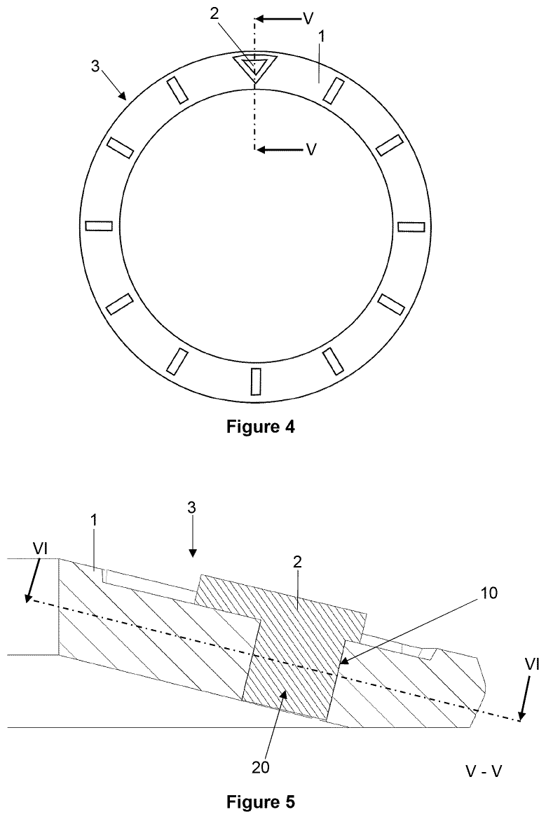

FIG. 4 represents a view from above of a timepiece assembly in a second embodiment. This timepiece assembly 3 comprises, as a second timepiece component 2, a ceramic applique assembled to a first timepiece component 1 that consists of a bezel disc.

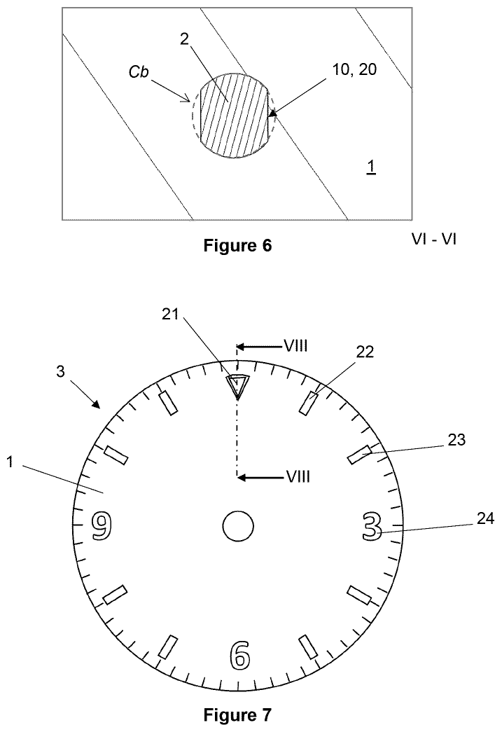

The applique includes a visible part of triangular shape, extended by a conformation 20 that takes the form of a peg inserted in an opening 10 in the bezel disc. In the second embodiment, the opening 10 is of non-cylindrical shape, in the form of a cylinder with flattened parts, and the conformation 20 of the applique is likewise a peg of non-cylindrical geometry complementary to that of the opening 10, and therefore includes flattened parts, as particularly visible in FIGS. 5 and 6. This non-cylindrical geometry has the function of correctly orienting the applique relative to the bezel disc. The cross sections of the opening 10 and the conformation 20 can be inscribed in a circle Cb having a diameter of 1 mm once the applique has been fixed to the disc, as represented in FIG. 6.

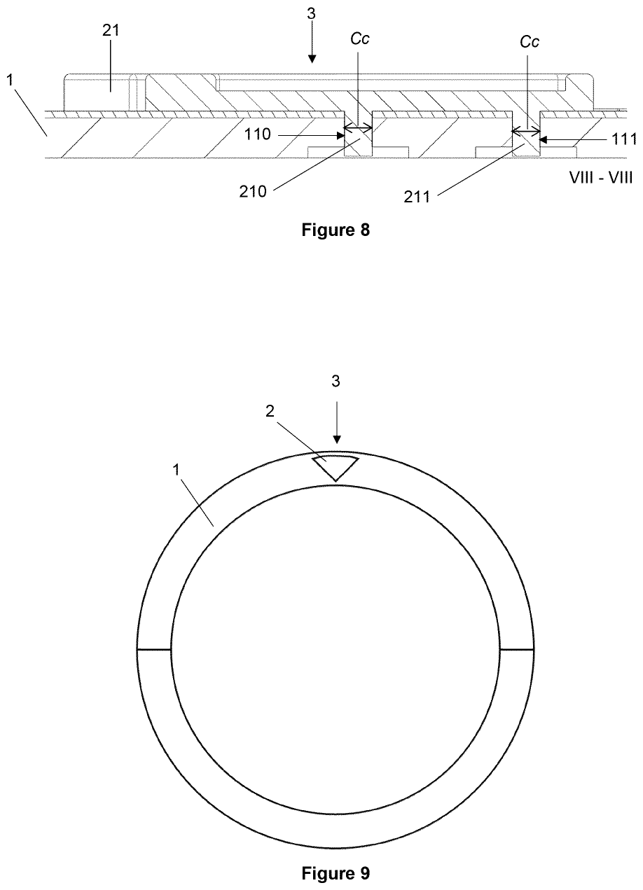

FIGS. 7 and 8 represent a timepiece assembly 3 in the form of a dial, enabling the assembly of a first timepiece component 1 that consists of a dial plate with a plurality of two timepiece components 2 that consist of appliques 21, 22, 23, 24. These appliques are noteworthy in that they each comprise two conformations in the form of cylindrical pegs designed to be housed in respective openings 10 of the dial plate in order to enable indexing thereof with respect to said dial plate. By way of example, FIG. 8 represents a view in section passing through the applique 21 disposed at the 12 h position on the dial plate. The two pegs 210, 211 of the applique 21 are here accommodated in respective openings 110, 111 of the dial plate. The openings 110, 111 and the conformations 210, 211 have a diameter of the order of 0.25 mm. In particular, the openings 110, 111 and the conformations 210, 211 can be inscribed in a circle Cc having a diameter of 0.25 mm once the applique 21 has been fixed to the dial plate.

FIG. 9 represents a timepiece assembly 3 in a fourth embodiment including a first timepiece component 1 corresponding to a bezel disc assembled to a second timepiece component 2 corresponding to an applique. This applique can be assembled to the bezel disc by an architecture of conformations/openings similar to that of the timepiece assembly 3 in FIG. 8. Finally, this fourth embodiment corresponds to a combination of the second embodiment represented in FIG. 4 and the third embodiment from FIG. 7.

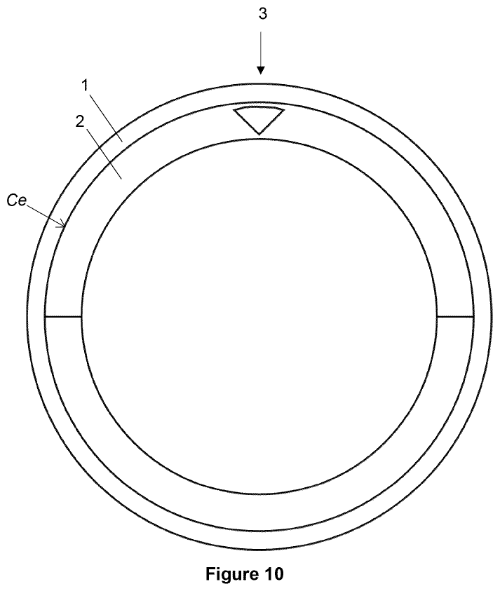

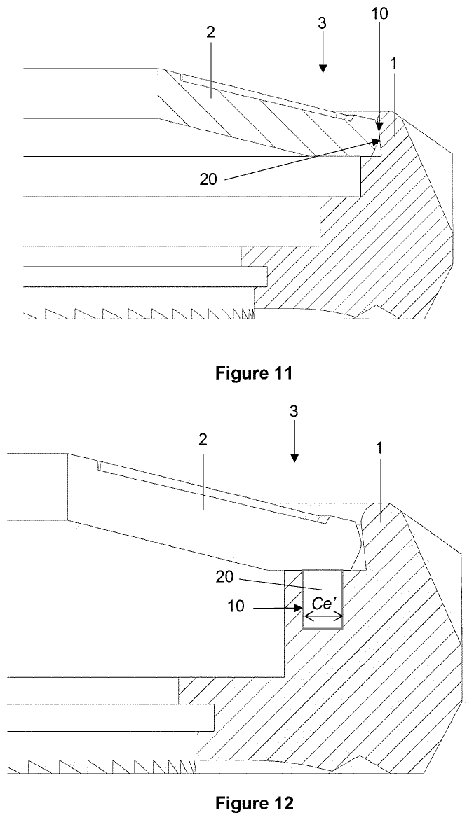

FIGS. 10 and 11 represent a timepiece 3 in a fifth embodiment. The first timepiece component 1 is a bezel ring comprising an opening 10 in the form of a peripheral groove. The second timepiece component 2 is a bezel disc the perimeter of which forms a conformation 20 that comes to be housed in the opening 20 so that the side of said opening 10 clamps the exterior perimeter forming a conformation 20 of the bezel disc. In this specific embodiment the opening 10 and the conformation 20 have an overall diameter of the order of 47 mm. In particular, the opening 10 and the conformation 20 can be inscribed in a circle Ce represented in FIG. 10 having a diameter of 47 mm once the bezel disc is clamped inside the bezel ring.

FIG. 12 illustrates a variant of the fifth embodiment in which the conformation 20 of the bezel disc comprises pegs that are designed so as to come to be housed in openings 10 in the bezel ring. By way of example, FIG. 12 represents a view in cross section at the level of a peg housed in an opening in the bezel ring. In this embodiment, the pegs are oriented in a vertical direction and are arranged in openings likewise arranged around a vertical axis. The pegs are distributed over the perimeter of the bezel disc in a regular or irregular manner. The openings are distributed over the bezel ring in a corresponding manner. The person skilled in the art will know how to adapt the shape and the positions of the openings (and of the corresponding pegs) as a function of the different linear deformations of the inside diameter of each opening and the distances between the latter. By way of example, an opening 10 and a corresponding conformation 20 have a diameter of the order of 1 mm.

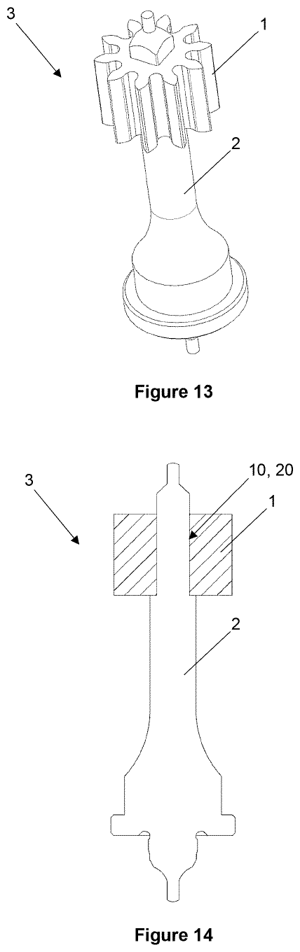

FIGS. 13 to 15 illustrates a timepiece assembly in a sixth embodiment, which consists of an arbor-mounted pinion, in particular an escapement pinion. The first timepiece component 1 is a pinion and the second timepiece component 2 is an arbor. The pinion comprises an opening 10 with a cross section of square shape and the arbor comprises a portion having a section complementary to that of the opening, forming a conformation, so that the timepiece assembly is a pinion mounted on a square on an arbor. The square makes it possible on the one hand to index the position of the pinion relative to the arbor and also constitutes a torque transmission element between the arbor and the pinion. The respective geometries of the sections of the opening 10 and of the conformation 20 can be inscribed in a circle Cf having a diameter of 0.3 mm once the pinion has been fixed to the arbor.

FIG. 16 illustrates a timepiece assembly 3 in a seventh embodiment, which again consists of an arbor-mounted pinion. In this embodiment, the first timepiece component 1 is an arbor which comprises a groove at its periphery forming an opening 10. The second timepiece component 2 is a pinion comprising a protrusion forming a conformation 20 intended to cooperate with the opening 10.

The invention is naturally not limited to the embodiments described above or to the particular geometries described. More generally, the first timepiece component 1 is a female component that comprises at least one opening 10 and the second timepiece component 2 is a male component that comprises at least one conformation 20 designed to be inserted in said opening 10, this conformation and this opening being able to have any appropriate shape and any appropriate dimensions. For example, the opening 10 can be a through-opening or a blind opening. The opening 10 can for example take the form of a hole or a groove. The opening 10 can preferably have a conical, cylindrical or non-cylindrical, oval or elliptical or polygonal shape, a circular or non-circular, ellipsoidal, polygonal cross section and/or comprise teeth or at least one flattened part. The section of the receiving opening can be open or closed. The first timepiece component 1 can comprise a plurality of openings 10.

The conformation 20 constitutes a portion of the second timepiece component 2. This portion may consist of the exterior perimeter of the second timepiece component 2 or a peg or more generally a protrusion on the timepiece component 2. More generally, the conformation can correspond to a portion constituting at least in part the body of the second component, such as an exterior wall of the timepiece component 2, or alternatively the conformation may be a specific added portion, such as a peg protruding from the main body of the second timepiece component. The conformation can comprise a plurality of distinct portions, for example a plurality of pegs, for example two pegs.

The section of the conformation 20 matches the section of the opening 10 and can therefore have a cylindrical or non-cylindrical, conical, polygonal cross section and/or comprise teeth or at least one flattened part. These dimensions of the conformation 20 and of a corresponding opening 10 are therefore substantially the same, so as to enable a clearance to be obtained in the temporary configuration that enables easy relative positioning thereof, while guaranteeing minimum mobility between the two timepiece components in the temporary positioning of the assembly before they are joint together. The distance between the two timepiece components at the level of their connection, that is to say forming the clearance between the conformation and the opening, is advantageously less than or equal to 4 μm or even less than or equal to 2 μm. This distance is also advantageously greater than or equal to 1 μm or even greater than or equal to 1.5 μm. The dimensions take into account the linear increase in the dimensions of the first timepiece component and more particularly of its opening 10 during the preliminary heat treatment, which is of the order 0.4% to 1.5%. The geometry of the timepiece components will advantageously be chosen to enable a sufficient clearance to be obtained before the heat treatment, in all cases enabling assembly thereof with a smaller clearance while achieving satisfactory joining together thereof in an acceptable time by the heat treatment. The conformation can thus have a dimension between that of the opening in the first timepiece component and that of that same opening enlarged by the preliminary heat treatment.

As mentioned, the dimensions of the conformation and of the opening can vary. For example, the section of the opening and of the conformation of the first and second timepiece components respectively can be inscribed in a circle having a diameter of 50 mm, even of 30 mm, even of 5 mm, even of 3 mm, even of 2 mm, even of 1 mm, even of 0.5 mm, after assembly. Before the first step the at least one opening has a first dimension. After the first step the at least one opening has a second dimension. The at least one conformation of the second component has a third dimension between the first and second dimensions of the at least one opening. This third dimension can notably be of the same order as that of the first dimension, to within fabrication tolerances.

The timepiece assembly can comprise a plurality of second timepiece components assembled onto the same first timepiece component or a plurality of first timepiece components assembled onto the same second timepiece component. In such a case, the timepiece assembly therefore involves more than two timepiece components. Such an assembly can be produced by the same method, in which at least three timepiece components can be assembled together simultaneously. Alternatively, the assembly method can be sequential, in order to assemble the components two by two, taking into account the fact that the components assembled beforehand will separate each time the preliminary heat treatment is carried out and be joint together again each time the heat treatment of joining together is completed.

The invention is naturally not limited to the embodiments described above by way of example in which the first timepiece component can be a bezel disc, a bezel, a bezel ring, a dial and the second timepiece component can be an applique, a bezel disc. The invention can be generalized to numerous timepiece assemblies, in particular in the domain of whatch exterior components, and can for example concern any component inside a watch case, a dial or a wristband.

The invention is not limited to the field of whatch exterior components and can also be used in the field of movement to assemble two components of the timepiece movement. By way of example, as described above, the first component can for example be a pinion and the second component an arbor, or vice versa. More generally, the invention can be applied to assemble any component of the movement, such as a ruby or such as a lever, a cam or any toothed component on an arbor.

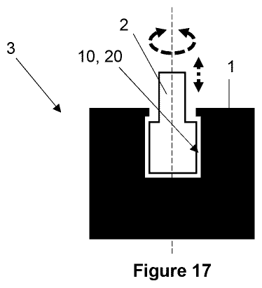

The invention also enables assembly of a second component onto a first component by joining together the first component and the second component while maintaining a degree of freedom between the two components, the second timepiece component remaining mobile relative to the first timepiece component. Thus FIG. 17 shows by way of example a timepiece assembly 3 in which a conformation 20 of a second timepiece component 2 is enclosed in an opening 10 of a first timepiece component 1. The second timepiece component 2 is therefore mobile in translation and mobile in rotation in the opening FIG. 10 but its conformation 20 cannot escape from this opening 10 the mouth of which has a dimension smaller than that of the conformation 20. Thus the two timepiece components are joint together. Thus in such an embodiment the heat treatment of joining together leads to the at least one conformation 20 of the second timepiece component 2 being imprisoned in a housing delimited by the at least one opening 10 of the first timepiece component 1, the two timepiece components 1, 2 being joint together in a mobile manner relative to one another.

On the other hand, as mentioned above, the invention has the advantage of being compatible with at least one first timepiece component made of an undeformed tetragonal phase sintered zirconia, as will be the case if it undergoes an assembly method other than that of the invention, such as driving, which would induce internal stresses inducing a non-negligible risk of the ceramic breaking. The first timepiece component therefore has no internal stress after assembly, particularly at the level of the connecting zone. A particular tetragonal phase zirconia able to change phase to a monoclinic phase at a temperature above 100 degrees Celsius, even between 100 and 400 degrees Celsius, at ambient pressure is more specifically used.

The particular tetragonal phase zirconia of the first timepiece component can notably be a sintered zirconia, in particular an yttriated zirconia, notably a 3% molar yttriated zirconia or a 2% molar yttriated zirconia. This zirconia can be colored by pigmentation and/or by impregnation. This zirconia can also include grains of different size to the grains of the particular zirconia of the first timepiece component. As mentioned above, not all zirconias have the aptitude for the phase change chosen for the invention. To this end, a plurality of factors determine this property and the person skilled in the art will know how to identify the particular zirconias suitable for implementing the invention. For example, it appears that the size of the grains after sintering the zirconia has an influence on the aptitude of the zirconia for such a phase change. Accordingly, the same black zirconia as that described in detail hereinabove but sintered with a shorter thermal cycle at a lower temperature (for example approximately 5 min at 1300° C. instead of 1 hour at 1350° C.) exhibits no aptitude for the phase change.

Even if the invention can be implemented on the basis of only one connecting portion (comprising at least one opening) made of such a zirconia, it is advantageous to use a first timepiece component that consists entirely of the same material. The first timepiece component advantageously takes a monobloc form, i.e. notably in a form of one piece.

The material of the second component can also be a ceramic, and even a zirconia, notably a zirconia that does not have the particular property of the zirconia of the first timepiece component. Accordingly, such a zirconia is chosen but is insensitive or negligibly insensitive to the heat treatments of the production method compared to the first timepiece component. Notably, this zirconia exhibits no phase change during the heat treatment of joining together, or only in a small proportion. Its coefficient of thermal expansion is substantially similar to or less than that of the zirconia of the first component so as not to induce stresses in the first component outside its elastic limit. As mentioned above, not all zirconias have the aptitude for the phase change of the zirconia chosen for the invention. To this end, a plurality of factors determine this property and the person skilled in the art will know how to identify the particular zirconias suitable for implementing the invention. This zirconia can be colored by pigmentation and/or by impregnation. This zirconia can also have grains of different size to the grains of the particular zirconia of the first timepiece component. It is therefore possible using the invention to assemble two black zirconia components if their properties, for example their grain sizes, are chosen judiciously. More generally, the zirconia of the second component is different from that of the first component. It can have a different finish, for example a matt finish compared to a polished finish. More generally, the material of the second timepiece component can be any technical ceramic insensitive to the heat treatments. It can for example be an alumina Al₂O₃, boron nitride BN, boron carbide B₄C, silicon nitride Si₃N₄, silicon carbide SiC, aluminum nitride AlN, boride and nitrides of Ti, Zr and Hf, or sapphire, or ruby or crystalline quartz. Alternatively, the material of the second component can be a refractory a metal (Pt, W), a cermet or a glass (molten quartz glass).

The invention also relates to a timepiece movement that comprises one or more timepiece assemblies as described above.

The invention also relates to a timepiece that comprises at least one timepiece assembly as described above or such a timepiece movement.

Note that the invention has been described in detail on the basis of a female connecting portion of the first component that enables joining together as a result of a phase change of a zirconia that constitutes the base of that connection portion. Alternatively, such a phase change of a particular zirconia that constitutes the base of a connection part, as described above, can be used to achieve the joining together the second timepiece component that has a connection part based on a sintered zirconia, more precisely its conformation forming a male connecting portion. Indeed, if such a conformation undergoes a total or partial phase change from a tetragonal phase to a monoclinic phase, in accordance with the principle of the preliminary heat treatment described above, then it results in an expansion, that is to say in an increase of its dimensions, that can also lead to clamping in an opening of the first component. Accordingly, all the embodiments described above can be implemented on the basis of a sintered zirconia part of the conformation of the second timepiece component that changes phase and increases its dimensions. After the two timepiece components have been joint together this sintered zirconia part has therefore undergone a phase change from tetragonal to monoclinic.

In this embodiment at least the connecting portion of the first timepiece component can be made of one of the materials mentioned for the second timepiece component in the foregoing embodiments.

The invention therefore also relates to a method of producing a timepiece assembly wherein a conformation of the second timepiece component forms a part based on a sintered zirconia, the method comprising the following steps:
assembling two timepiece components in an intermediate configuration so that the at least one conformation of the second timepiece component is positioned in the opening of the connecting portion of the first timepiece component;
subjecting said timepiece assembly in its intermediate configuration to the heat treatment of joining together so as to induce a phase change of the zirconia of the conformation of the second timepiece component from the tetragonal phase to the monoclinic phase, which induces an expansion of said at least one conformation of the second timepiece component, thereby joining the first and second timepiece components of the timepiece assembly together in a final configuration.

Note that in this embodiment, the conditions of the heat treatment of joining together correspond to the preliminary heat treatment in the embodiments described above.

In accordance with another approach, at least the two connecting portions of the two timepiece components, that is to say the connecting portions comprising the opening and the conformation, could be made of the same material based on the particular sintered zirconia described in detail above. In such a case, during the heat treatment of joining together the two portions to be connected could undergo a change of dimension. The conformation, being initially in the tetragonal phase, would undergo a phase change at the start of the heat treatment of joining together, in the range from 100°−400° C., from the tetragonal phase to the monoclinic phase. In this range, the opening can only increase in size or remain unchanged. Because of this, during the temperature rise the two components are in an expanded state and can already be joint together. During the remainder of the heat treatment of joining together, in the range 400°−1300° C., the two components, being in the monoclinic phase and potentially already joint together, will simultaneously undergo the phase change from monoclinic to tetragonal, until a final joining together is obtained, remaining in the tetragonal phase, as described above.

Finally, the method of the invention exploits the concept of modifying the dimensions of at least one part based on a sintered zirconia during a phase change from tetragonal to monoclinic and vice versa to join together two timepiece components.

1. A method of producing a timepiece assembly comprising a first timepiece component comprising a connecting portion comprising at least one opening and at least one second timepiece component distinct from the first timepiece component comprising at least one conformation, the connecting portion of the first timepiece component and/or the conformation of the second timepiece component forming a part based on a sintered zirconia,
wherein the method comprises:
performing a heat treatment of joining together, the heat treatment being predefined to induce a phase change from the tetragonal phase to the monoclinic phase, or from the monoclinic phase to the tetragonal phase, of the part based on a sintered zirconia, wherein the phase change induces a change of the dimensions of at least the part based on a sintered zirconia so as to join together the connecting portion of the first timepiece component and the conformation of the second timepiece component.

2. The method as claimed in claim 1, wherein the conformation of the second timepiece component forms the part based on a sintered zirconia, wherein the method comprises:
assembling the first and second timepiece components in an intermediate configuration so that the at least one conformation of the second timepiece component is positioned in the at least one opening of the connecting portion of the first timepiece component;
subjecting the timepiece assembly in the intermediate configuration to the heat treatment of joining together so as to induce a phase change of the zirconia of the conformation of the second timepiece component from the tetragonal phase to the monoclinic phase, which induces an expansion of the at least one conformation of the second timepiece component, to thereby join together the first and second timepiece components of the timepiece assembly in a final configuration.

3. The method as claimed in claim 1, wherein the connecting portion of the first timepiece component forms the part based on a sintered zirconia, wherein the method comprises:
subjecting the first timepiece component to a preliminary heat treatment so as to induce a first phase change of the zirconia of the connecting portion from the tetragonal phase to the monoclinic phase, the first phase change inducing enlargement of the at least one opening of the first timepiece component;
assembling the first and second timepiece components in an intermediate configuration so that the at least one conformation of the second timepiece component is positioned in the at least one opening in the connecting portion of the first timepiece component;
subjecting the timepiece assembly in the intermediate configuration to the heat treatment of joining together to induce a second phase change of the zirconia of the connecting portion of the first timepiece component from the monoclinic phase to the tetragonal phase, which induces shrinkage of the at least one opening of the first timepiece component, thereby joining together the first and second timepiece components of the timepiece assembly in a final configuration.

4. The method as claimed in claim 3, wherein the preliminary heat treatment is carried out at a pressure below 2 atm and at a temperature in a range of from 100 to 400 degrees Celsius.

5. The method as claimed in claim 1, wherein the heat treatment of joining together is carried out at a pressure below 2 atm and at a temperature in a range of from 1100 to 1300 degrees Celsius.

6. The method as claimed in claim 1, wherein one of the first and second timepiece components comprises the part based on a sintered zirconia and the other of the first and second timepiece components is made of a material having a negligible change of dimensions relative to a change of dimensions of the part based on a sintered zirconia during the heat treatment of joining together.

7. The method as claimed in claim 6, wherein all or part of the other of the first and second timepiece components is based on technical ceramic, or all or part of the other of the first and second timepiece components is made of a refractory material.

8. The method as claimed in claim 1, wherein
a cross section of the at least opening of the connecting portion of the first timepiece component is inscribed in a circle having a diameter less than or equal to 50 mm, and/or
a change in dimensions of the at least one part based on a sintered zirconia following the preliminary heat treatment is in a range of from 0.4% to 1.5%, and/or
the at least one conformation has a dimension substantially equal to a dimension of the at least one opening in the connecting portion of the first timepiece component.

9. The method as claimed in claim 1, wherein
the at least one opening in the connecting portion of the first timepiece component has a cylindrical or non-cylindrical shape, or a section with one or more flattened parts, and/or
the at least one conformation of the second timepiece component has a geometry complementary to a geometry of the opening in the connecting portion of the first timepiece component.

10. The method as claimed in claim 1, wherein
the timepiece assembly comprises the second timepiece component and at least one third timepiece component assembled to the first timepiece component, or
the second timepiece component comprises a plurality of conformations cooperating with respective openings in the first timepiece component.

11. The method as claimed in claim 1, wherein
the subjecting of the timepiece assembly to a heat treatment of joining together leads to clamping the at least one opening of the first timepiece component by shrinking the first timepiece component onto the at least one conformation of the second timepiece component and/or clamping the at least one opening in the first timepiece component onto the at least one conformation of the second timepiece component by enlarging the conformation and joining together of the first and second timepiece components, or
the subjecting of the timepiece assembly to a heat treatment of joining together leads to trapping the at least one conformation of the second timepiece component in a housing delimited by the at least one opening in the first timepiece component, the first and second timepiece components being jointed together so that the first and second timepiece components mobile relative to one another.

12. A timepiece assembly comprising
a first timepiece component comprising a connecting portion based on a tetragonal phase zirconia comprising at least one opening, and at least one distinct second timepiece component comprising at least one conformation, or
a first timepiece component comprising a connecting portion comprising at least one opening, and at least one distinct second timepiece component comprising at least one conformation based on a monoclinic phase zirconia,
wherein the first timepiece component (Hand the second timepiece component are clamped without deformation of the opening in the first timepiece component on the at least one conformation of the second timepiece component.

13. A timepiece assembly comprising
a first timepiece component comprising a connecting portion based on a tetragonal phase zirconia comprising at least one opening, and at least one distinct second timepiece component comprising at least one conformation, or
a first timepiece component comprising a connecting portion comprising at least one opening, and at least one distinct second timepiece component comprising at least one conformation based on a monoclinic phase zirconia,
wherein the first timepiece component and the second timepiece component are joined together so that the first and second timepiece components are mobile relative to one another by positioning the at least one conformation of the second timepiece component in a housing delimited by the at least one opening in the first timepiece component.

14. The timepiece assembly as claimed in claim 12, wherein the connecting portion of the first timepiece component is based on a tetragonal phase zirconia adapted to change phase to a monoclinic phase at a temperature in a range of from 100 to 400 degrees Celsius and at a pressure below 2 atm.

15. The timepiece assembly as claimed in claim 12, wherein
one of the first and second timepiece components of the timepiece assembly comprises a part based on a tetragonal or monoclinic zirconia and the other of the two timepiece components of the timepiece assembly is in whole or in part based on a technical ceramic having a negligible change in dimensions compared to a change in dimensions of the at least one part based on a tetragonal or monoclinic zirconia during a heat treatment of joining together, or
the at least one conformation of the second timepiece component is made of a refractory material.

16. The timepiece assembly as claimed in claim 12, wherein
the at least one conformation of the second timepiece component is a protrusion or a peg or a portion of the body of the second timepiece component, or
the first timepiece component is a bezel or a bezel ring and the second timepiece component is a bezel disc, or
the first timepiece component is a bezel disc, a bezel, a dial, or a wristband and the second timepiece component is an external part, or
the first timepiece component is a pinion, a lever, a cam, a ruby, or a toothed component, and the second timepiece component is an arbor, or
the first timepiece component is an arbor and the second timepiece component is a pinion, a lever, a cam, or a toothed component.

17. A timepiece comprising a timepiece assembly as claimed in claim 12.

18. The timepiece assembly as claimed in claim 14, wherein the connecting portion of the first timepiece component is based on a tetragonal phase zirconia adapted to change phase to a monoclinic phase at a temperature of 100 degrees Celsius and at ambient pressure.

19. The timepiece assembly as claimed in claim 15, wherein one of the first and second timepiece components of the timepiece assembly comprises a part based on a tetragonal or monoclinic zirconia and the other of the two timepiece components of the timepiece assembly is in whole or in part based on a technical ceramic having a negligible change in dimensions compared to a change in dimensions of the at least one part based on a tetragonal or monoclinic zirconia during a heat treatment of joining together, wherein the technical ceramic is selected from the group consisting of a zirconia different from that of the part based on a tetragonal or monoclinic zirconia, alumina (Al2O3), boron nitride (BN), boron carbide (B4C), silicon nitride (Si3N4), silicon carbide (SiC), aluminum nitride (AlN), borides and nitrides of Ti, Zr and Hf, or based on sapphire, or based on ruby or based on crystalline quartz.

20. The timepiece assembly as claimed in claim 15, wherein the at least one conformation of the second timepiece component is made of a refractory material, wherein the refractory material is a metal, a cermet, or a glass.
